(19) United States
(12) Patent Application Publication
(10) Pub. No.: US 2026/0203801 A1
(43) Pub. Date: Jul. 16, 2026

(54) System and Method for Boat Ride-Sharing and Marine Assistance Services

(71) Applicant: Robin Thompson, Merritt Island, FL (US)

(72) Inventor: Robin Thompson, Merritt Island, FL (US)

(21) Appl. No.: 19/085,591

(22) Filed: Mar. 20, 2025

Related U.S. Application Data
(60) Provisional application No. 63/743,680, filed on Jan. 10, 2025.

(51) Int. Cl. G06Q 30/0601; G01C 21/20; G06Q 50/47

(52) U.S. Cl. CPC G06Q 30/0611; G01C 21/203; G06Q 30/0609; G06Q 50/47

(57) ABSTRACT

The present invention is a system and method for boat ride-sharing and marine assistance services via a communication network that connects customers and marine drivers through mobile applications. The system includes a customer mobile application for requesting services such as ride sharing, fuel delivery, towing, temporary marine drivers, and emergency assistance, and a marine driver mobile application for accepting requests and fulfilling services. Both applications communicate with a server system that manages customer and driver profiles, processes requests, matches customers with nearby marine drivers based on parameters including proximity, certifications, and service preferences, and tracks real-time locations using GPS. A payment gateway facilitates electronic transactions, and an advertising module provides location-based advertisements. The method includes identifying suitable drivers, broadcasting service requests, providing real-time tracking, and processing payments.

### CROSS-REFERENCE TO RELATED APPLICATION

The present application claims priority to, and the benefit of, U.S. Provisional Application No. 63/743,680, which was filed on January 10, 2025, and is incorporated herein by reference in its entirety.

### FIELD OF THE INVENTION

The present invention generally relates to systems for providing boat ride-sharing and marine assistance services. More specifically, the invention relates to a platform that connects customers and marine drivers through mobile applications to facilitate on-demand marine transportation and support. The system includes a customer mobile application to enable users to request services such as ridesharing, fuel delivery, and temporary marine drivers, with features for real-time tracking and seamless communication. A marine driver mobile application enables marine drivers to accept requests, track customer locations, and receive payments. The server system, integrated with GPS technology, ensures accurate real-time location tracking and efficient driver-customer matching. Accordingly, the present disclosure makes specific reference thereto. Nonetheless, it is to be appreciated that aspects of the present invention are also equally applicable to other like applications, devices, and methods of manufacture.

### BACKGROUND

By way of background, in recent years, ride-sharing services for land transportation have seen widespread development and commercialization. Companies such as Uber and Lyft have revolutionized the transportation industry by providing digital platforms that enable private citizens to connect with drivers for transportation services. Such platforms operate via mobile applications that users download onto their devices, creating accounts to request rides, track their progress, and process payments seamlessly.

The systems leverage GPS and other geo-aware technologies to identify user locations, find the nearest available drivers, calculate routes and pricing, and optimize service delivery. The flexibility offered by the conventional ride-sharing platforms enables drivers to set their schedules, using their personal vehicles to earn income by working as much or as little as they choose. While these services have become ubiquitous for land travel, there is a lack of a similar solution tailored for marine transportation and assistance needs.

Therefore, there exists a long-felt need in the art for a system that addresses the challenges of marine transportation and assistance by providing an on-demand platform for boat ride-sharing and marine support services. Specifically, there is a need for a solution that enables customers to request transportation via boats, hire temporary captains to operate their vessels, and receive prompt delivery of fuel or mechanical parts. Additionally, there is a long-felt need for a system that uses advanced technologies such as GPS and automated payment gateways to provide efficient service matching and payment processing. Furthermore, there exists a need for a solution tailored to both recreational and emergency marine needs, ensuring convenience, reliability, and safety for customers. Finally, there exists a long-felt need in the art for a system that connects customers and marine drivers through a mobile application, enabling real-time tracking, customizable services, and transparent communication.

The subject matter disclosed and claimed herein, in one embodiment, comprises a state-of-the-art system for boat ridesharing and assistance. The system includes a customer mobile application installed on handheld electronic devices, providing user interfaces to request services such as ridesharing, fuel delivery, and temporary marine drivers. A marine driver mobile application, installed on devices of boat operators, offers features for accepting service requests, tracking customer locations, and processing payments. Both applications communicate with a centralized server system that manages customer and driver profiles, processes service requests, and matches customers with nearby marine drivers based on parameters like proximity, certifications, and customer preferences. The server incorporates a matching module for efficient service allocation and a payment gateway for secure, automated transactions. In one embodiment, the system also includes an advertising module to deliver location-based advertisements for marine-related businesses.

In this manner, the boat ridesharing and assistance system of the present invention fulfills the aforementioned needs by offering an innovative, scalable, and user-friendly platform for marine transportation and support services. The system provides real-time service matching, enhances safety through verified driver profiles, and simplifies payment processing with integrated gateways. The system eliminates common inefficiencies in marine assistance by providing a streamlined interface for requesting and fulfilling services.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a system for providing boat ride-sharing and marine assistance services. The system comprises a customer mobile application adapted to be installed on a customer device, wherein the customer mobile application provides user interfaces for requesting services, tracking boat locations, making payments, and communicating with drivers, a marine driver mobile application is adapted to be installed on a marine driver device, wherein the marine driver mobile application provides user interfaces for accepting service requests, tracking customer locations, and receiving payments, a server system is in communication with the customer mobile application and the marine driver mobile application via a communication network, the server system is configured to receive service requests from customers, maintain a customer profile database storing customer information, including contact details, transaction history, and reviews, maintain a marine driver profile database storing driver information, including certifications, licenses, and ratings, identify and assign nearby marine drivers to customer requests based on parameters including proximity, driver certifications, and customer preferences, and process payments between customers and drivers using an integrated payment gateway supporting multiple payment methods.

In another aspect, a system for real-time matching and tracking of marine drivers for ridesharing and assistance services is disclosed. The system includes GPS-enabled customer and driver devices configured to provide real-time location data, a matching module hosted on a server, the matching module configured to receive real-time location data of customers and drivers, broadcast service requests to nearby marine drivers within a predetermined radius, filter drivers based on certifications, reviews, boat size compatibility, and customer-specific requirements, and a payment gateway configured to automatically (i.e., autonomously) process payments upon service completion.

In one embodiment, a method for providing boat ridesharing and assistance services is described. The method includes receiving, via a customer mobile application, a service request from a customer, the request including service type, customer location, and preferences, transmitting the service request to a server system, wherein the server identifies one or more nearby marine drivers based on proximity, certifications, and other parameters, broadcasts the service request to the identified drivers, receiving acceptance of the service request from a marine driver via a marine driver mobile application, providing the customer with real-time tracking of the marine driver’s location via the customer mobile application, completing the requested service by the driver, and processing payment for the service through an integrated payment gateway.

In still another embodiment, a computer-implemented method for managing boat ridesharing and assistance services is disclosed. The method includes receiving a service request from a customer through a mobile application installed on a customer device, detecting the real-time location of the customer using a GPS module of the customer device, querying a database of registered drivers (i.e., boat captains) to identify one or more marine drivers meeting predefined criteria, including proximity, certifications, and boat service type, transmitting the service request to the identified drivers and receiving acceptance from one driver, displaying, on the customer device, real-time tracking information of the assigned driver and estimated time of arrival, automatically (i.e., autonomously) processing payment from the customer to the driver using a payment gateway, and updating customer and driver profiles in respective databases with transaction and review data.

In yet another aspect, the method includes receiving a fuel delivery request from a customer via a mobile application, identifying the customer’s location using GPS data from the customer’s device, locating a nearby fuel provider based on the customer’s location, assigning a marine driver located near the fuel provider to fulfill the request, and completing the delivery service by the driver.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of boat ride sharing and assistance system of the present invention in accordance with the disclosed structure;

FIG. 2 illustrates a flow chart depicting a process assignment of a marine driver based on a customer service request in accordance with the disclosed architecture;

FIG. 3 illustrates a flow chart depicting a process of service fulfilment by a marine driver in accordance with the disclosed architecture;

FIG. 4 illustrates a flow chart depicting a process of processing a fuel delivery request in accordance with one embodiment of the present invention;

FIG. 5 illustrates a flow chart depicting a process of providing boat assistance to a user using the system of the present invention;

FIG. 6 illustrates a flow chart depicting a process of arranging a marine driver for driving a boat of a customer in accordance with the disclosed architecture;

FIG. 7 illustrates an exemplary user interface displayed by the customer mobile application when requesting a service in accordance with the disclosed architecture; and

FIG. 8 illustrates another user interface displayed by the customer mobile application in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system that addresses the challenges of marine transportation and assistance by providing an on-demand platform for boat ride-sharing and marine support services. Specifically, there is a need for a solution that enables customers to request transportation via boats, hire temporary captains to operate their vessels, and receive prompt delivery of fuel or mechanical parts. Additionally, there is a long-felt need for a system that uses advanced technologies such as GPS and automated payment gateways to provide efficient service matching and payment processing. Furthermore, there exists a need for a solution tailored to both recreational and emergency marine needs, ensuring convenience, reliability, and safety for customers. Finally, there exists a long-felt need in the art for a system that connects customers and marine drivers through a mobile application, enabling real-time tracking, customizable services, and transparent communication.

The present invention, in one exemplary embodiment, is a computer-implemented method for managing boat ridesharing and assistance services. The method includes receiving a service request from a customer through a mobile application installed on a customer device, detecting the real-time location of the customer using a GPS module of the customer device, querying a database of registered drivers (i.e., boat captains) to identify one or more marine drivers meeting predefined criteria, including proximity, certifications, and boat service type, transmitting the service request to the identified drivers and receiving acceptance from one driver, displaying, on the customer device, real-time tracking information of the assigned driver and estimated time of arrival, automatically (i.e., autonomously) processing payment from the customer to the driver using a payment gateway, and updating customer and driver profiles in respective databases with transaction and review data.

Reference will now be made in detail to the present preferred embodiments of the invention, examples of which are illustrated in the accompanying drawings. Wherever possible, the same reference numerals are used in the drawings and the description to refer to the same or like parts.

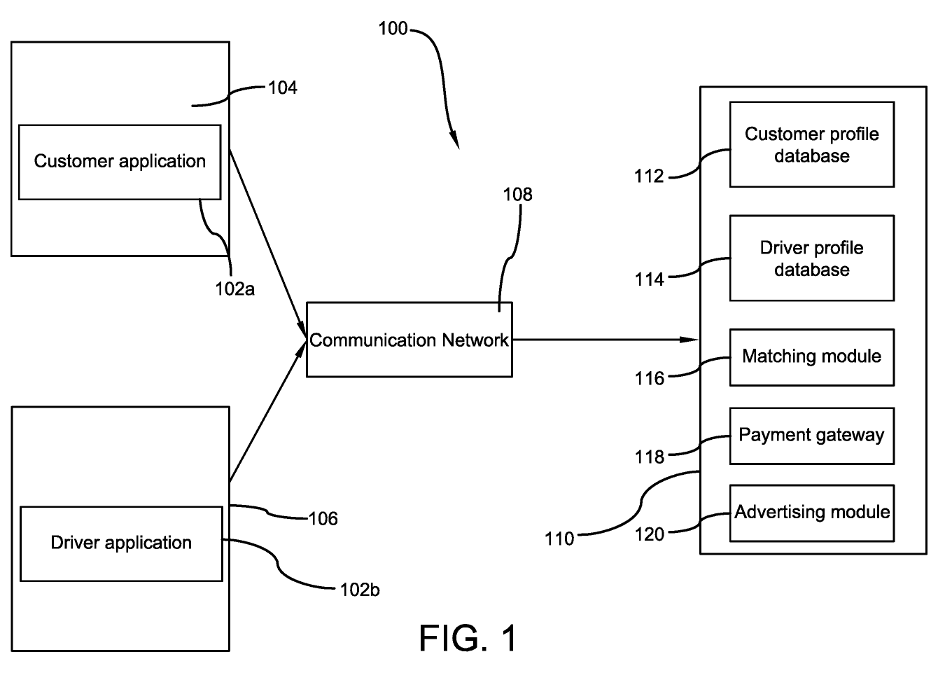

Referring initially to the drawings, FIG. 1 illustrates a schematic view of boat ride sharing and assistance system of the present invention in accordance with the disclosed structure. The boat ride sharing and assistance system 100 is designed to provide boat ride-sharing and marine assistance services via a communication network that connects customers with marine drivers using a mobile application. More specifically, the system 100 includes a customer mobile application 102a adapted to be installed in a handheld electronic communications device 104 also referred to as customer electronic device in the present disclosure. A marine driver mobile application 102b is installed in a marine driver electronic device 106 which can be any electronic computing device. The customer mobile application 102a provides a plurality of user interfaces for users, enabling the users to request different services, track boat locations, make payments, and more. The marine driver mobile application 102b is configured to provide a plurality of user interfaces to drivers for accepting requests from the customers, receiving payments, tracking locations, and more.

The system 100 includes a server system 110 which is configured to provide various services to enable boat riders or customers to request services through the mobile application 102a and enable marine drivers and technicians to receive/accept requests from the customers and to provide aid to the customers. The applications 102a, 102b and the server 110 extend the convenience and functionality of modern ride-sharing platforms to the boating industry. The applications 102a, 102b communicate with the server 110 via a communication network 108 such as Internet.

The server 110 includes a customer profile database 112 which stores customer information including but not limited to contact information, transaction history, ratings, reviews, and more. A marine driver profile database 114 stores contact information of drivers along with their certifications, license details, training details, reviews, ratings, and more. A matching module 116 is designed to identify nearby marine drivers based on parameters like proximity and boat service type for customer requests. The matching module 116 automatically (i.e., autonomously) transmits or broadcasts the service request from a customer to all the identified nearby marine drivers, wherein the marine drivers can accept or decline the service request based on their preferences.

It should be noted that the devices 104, 106 of the customers and the marine drivers are GPS-enabled devices and the system 100 tracks the real-time location of all registered drivers (i.e., boat captains) and the customers. The matching module 116 uses the location of the customers and the marine drivers to the find the nearest available driver relative to the customers. Further, certification of a marine driver for a specific marine vessel is also considered while broadcasting the service request from a customer to nearby marine drivers. Other parameters such as ratings, reviews, capacity of boat, certification of the driver, and customer demands, and more can be considered to filter out the marine drivers based on specific customer requirements.

A payment gateway 118 is configured to process the payments electronically and transfer funds between customer accounts and driver accounts. The payment gateway 118 can support different payment methods including but not limited to credit cards, debit cards, gift cards, digital wallets, and more. An advertising module 120 is included in the system 100 and provides location-based advertisements of various marine vessel manufacturers, boat maintenance companies, guides, restaurants, and more.

Examples of the user devices 104, 106 may include, but are not limited to, a desktop, a notebook, a laptop, a handheld computer, a touch sensitive device, a computing device, a smart-phone, and/or a smart watch. It will be apparent to a person of ordinary skill in the art that the user devices 104, 106 may include any device/apparatus that is capable of manipulation by the user.

The communication data between the applications and the server may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

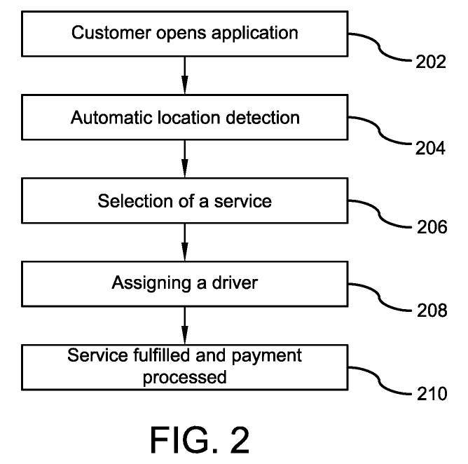

FIG. 2 illustrates a flow chart depicting a process assignment of a marine driver based on a customer service request in accordance with the disclosed architecture. For requesting a boat service, a customer opens the application 102a in the customer device 104 (Step 202). The application 102a, using the GPS module of the device 104, detects the real-time location of the customer (Step 204) and the server 110 receives the location. Then, a specific service is selected by the customer as per their preference (Step 206). The system 100 provides a plurality of services including boat ride sharing, delivery of fuel and spare parts, towing services, charter services, marine drivers, and more and a customer can select any services using the application 102a.

Based on the selection of a service, a marine driver is assigned to fulfil the customer request (Step 208). The system 100 broadcasts the service request to drivers who are nearby (such as within a predetermined radius) and a marine driver can accept or decline the request. Finally, the assigned driver fulfils the request and upon fulfilment of the request, the payment is processed and is transferred from the customer’s account to the marine driver’s account (Step 210).

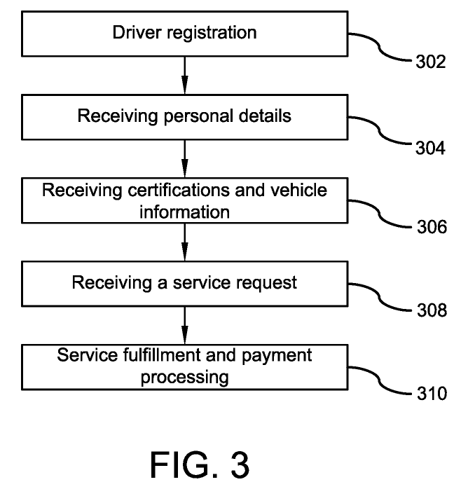

FIG. 3 illustrates a flow chart depicting a process of service fulfilment by a marine driver in accordance with the disclosed architecture. Initially, for the first time, a marine driver registers in the system 100 using the application 102b (Step 302). Then, the personal details such as name, qualifications, account information, and more are received from the marine driver and are stored in the marine driver profile database 114 (Step 304). The system 100 enables only authorized and trained marine drivers, and accordingly, receives certifications, licensing information, and their vehicle information for authentication and authorization (Step 306).

The driver receives a service request from a customer based on proximity between the driver and the customer, and other parameters set by the customer (Step 308). Upon acceptance of the request, the driver fulfils the request and payment for the request is processed (Step 310).

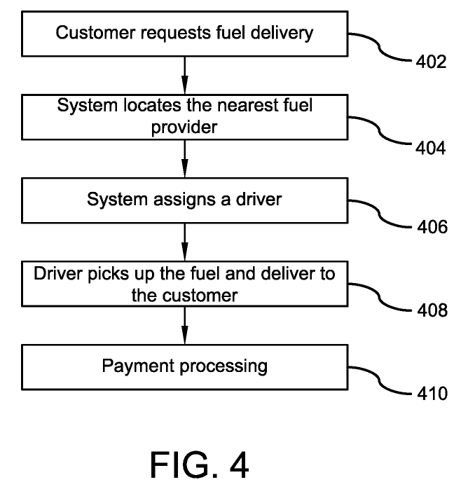

FIG. 4 illustrates a flow chart depicting a process of processing a fuel delivery request in accordance with one embodiment of the present invention. Initially, a customer requests fuel delivery using the application 102a (Step 402). Upon receiving the request, the nearest fuel provider is located based on location of the customer (Step 404) and a marine driver nearby the fuel provider is identified and is assigned the service request (Steo 406). Then, the assigned driver picks up the fuel from the fuel provider and delivers to the customer (Step 408). Finally, upon completion of the service request, payment processing is performed, and payment is transferred to the driver (Step 410). In the preferred embodiment, the customer pays for the fuel before assignment of the driver.

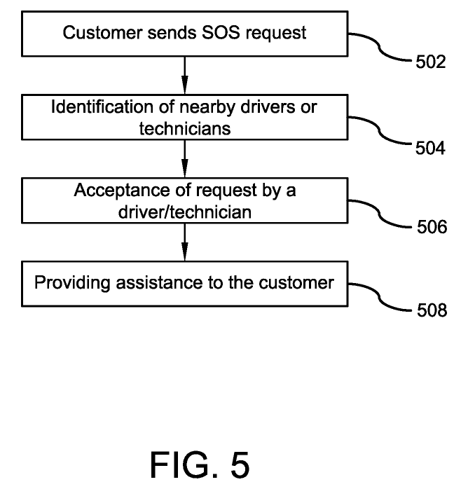

FIG. 5 illustrates a flow chart depicting a process of providing boat assistance to a user using the system of the present invention. The system 100 can be used to provide assistance to stranded boaters with fuel, towing, or parts delivery. For receiving assistance, a boat customer sends an SOS request using the application 102a (Step 502). Based on location of the customer, one or more marine drivers or technicians are identified, and request is broadcasted (Step 504). Upon acceptance of the request by a technician, a notification is provided to the customer along with an estimated ETA of the technician (Step 506). Finally, the assistance is provided by the technician to the customer and payment is processed (Step 508).

It should be noted that in some embodiments, a cost of service along with estimated time of arrival of the driver or technician is provided and displayed to the customer. If a marine driver or technician is not available, then notification is provided to the customer.

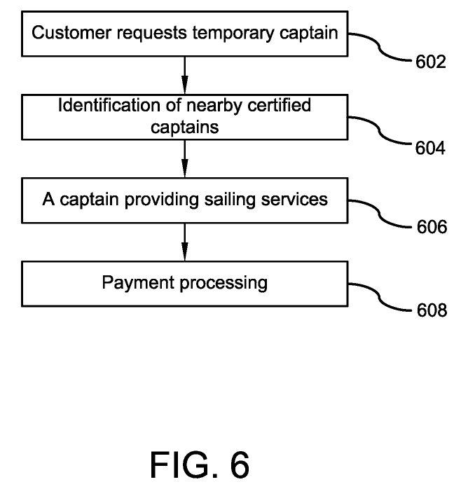

FIG. 6 illustrates a flow chart depicting a process of arranging a marine driver for driving a boat of a customer in accordance with the disclosed architecture. The system 100 can be used for requesting temporary captains for recreational boating or emergencies and as illustrated, initially, a boat owner requests a temporary captain using the application 102a (Step 602). The request may include the destination, distance, type of boat, and more. Then, based on location of the boat owner and the certifications of the boat captains, one or more boat captains are identified, and request is transmitted for acceptance (Step 604). Then, a captain who accepts the request provides marine services to the customer (Step 606). Finally, upon completion of the marine service, the payment is processed automatically (i.e., autonomously) and is transferred to the captains’ account (Step 608).

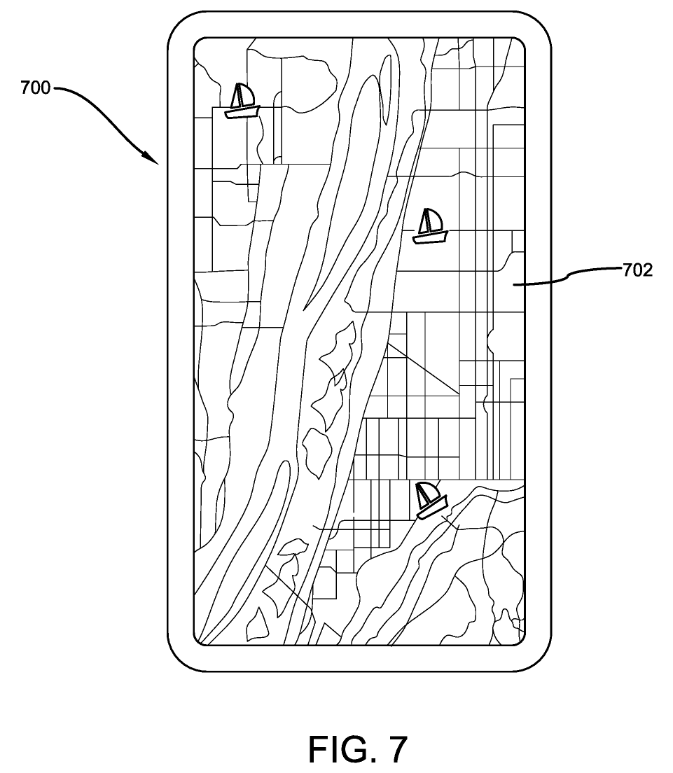

FIG. 7 illustrates an exemplary user interface displayed by the customer mobile application when requesting a service in accordance with the disclosed architecture. As illustrated, the interface 700 displays a digital map 702 which shows different captains/drivers/technicians available nearby based on type of service request. The map 702 displays real-time status of the nearby marine drivers and more.

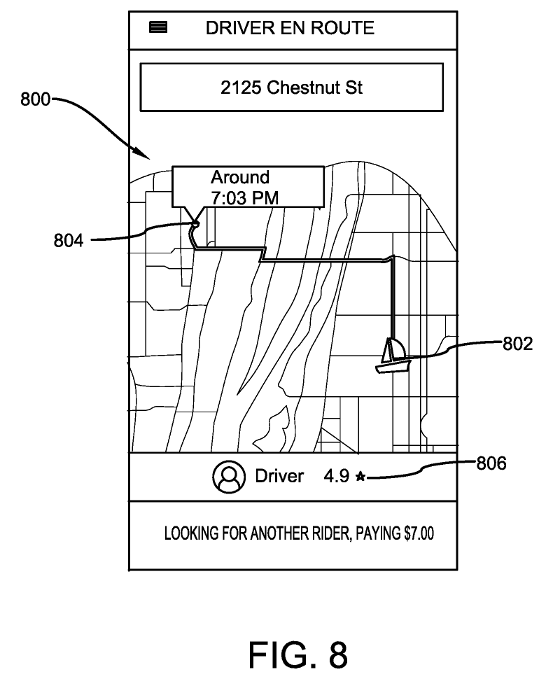

FIG. 8 illustrates another user interface displayed by the customer mobile application in accordance with the disclosed architecture. As illustrated, the distance and time between the selected captain/driver/technician 802 and the customer 804 is displayed in the interface 800. Also, rating 806 of the driver is also displayed and based on preference of the customer 804, any other captain/driver/technician can be selected by the customer.

Using the system, the customers can pre-plan their journeys by scheduling trips with available marine drivers or fleet operators. Customers can filter and select boats and/or marine drivers based on specific attributes such as boat type (e.g., speedboat, yacht, fishing boat), passenger capacity, ratings of drivers, and more. For each request accepted by a marine driver, the customers receive a notification which can include details such as the marine driver’s name, boat information, and estimated arrival time. Customers can also communicate with the assigned driver via the applications 102a, 102b and can send requests such as pickup location adjustments, changes in destination, or additional instructions. If a customer needs more time before the boat arrives, they can request a delay; or customers can adjust the scheduled time to an earlier slot if the marine driver’s availability permits.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “boat ride-sharing and marine assistance services system”, “on-demand boat transportation and marine support services system”, “boat ride sharing and assistance system”, and “system” are interchangeable and refer to the boat ride-sharing and marine assistance services system 100 of the present invention.

Notwithstanding the forgoing, the boat ride-sharing and marine assistance services system 100 of the present invention can be of any suitable configuration as is known in the art without affecting the overall concept of the invention, provided that it accomplishes the above stated objectives. One of ordinary skill in the art will appreciate that the boat ride-sharing and marine assistance services system 100 as shown in the FIGS. are for illustrative purposes only, and that many other configurations of the boat ride-sharing and marine assistance services system 100 are well within the scope of the present disclosure. Although the dimensions of the boat ride-sharing and marine assistance services system 100 are important design parameters for user convenience, the boat ride-sharing and marine assistance services system 100 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A boat ride sharing and marine assistance system comprising:
a customer electronic device having a customer mobile application;
a marine electronic device having a marine driver mobile application;
a communication network connecting said customer electronic device and said marine electronic device;
a server system;
wherein said server system provides access to a plurality of customer services for said customer mobile application and said marine driver mobile application;
wherein said customer mobile application having a plurality of customer interfaces for customers to request said plurality of customer services;
wherein said marine driver mobile application having a plurality of marine driver interfaces for marine drivers to accept said plurality of customer services;
wherein said plurality of customer services are selected from the group consisting of a tracking a boat location, tracking a customer location, a boat service type, making a payment, receiving a payment;
wherein said server system having a customer profile database including customer information selected from the group consisting of contact information, transaction history, ratings, and reviews;
wherein said server system having a marine driver profile database including marine driver information selected from the group consisting of certifications, license details, training details, reviews, and ratings; and
further wherein said boat service type is selected from the group consisting of boat ride sharing, delivery of fuel, delivery of spare parts, towing services, captaining services, and charter services.

2. The boat ride sharing and marine assistance system of claim 1, wherein said server system having a matching module to identify the marine drivers based on parameters of said plurality of customer services.

3. The boat ride sharing and marine assistance system of claim 2, wherein said server system having said matching module to identify the marine drivers based on proximity between the customer and the marine driver.

4. The boat ride sharing and marine assistance system of claim 3, wherein said matching module autonomously broadcasts said plurality of customer services requested from the customer to all the identified marine drivers.

5. The boat ride sharing and marine assistance system of claim 4, wherein the marine drivers can accept or decline the request of said boat service type.

6. The boat ride sharing and marine assistance system of claim 5, wherein said customer electronic device and said marine electronic device are GPS-enabled devices for detecting a real-time location of said customer electronic device and said marine electronic device.

7. The boat ride sharing and marine assistance system of claim 6, wherein said server system tracks the real-time location of said customer electronic device and said marine electronic device of all marine drivers and customers.

8. The boat ride sharing and marine assistance system of claim 7, wherein said matching module uses the real-time location of the customers and the marine drivers to find the nearest available marine driver relative to the customer.

9. A method of boat ride sharing and marine assistance, the method comprising the steps of:
providing a customer electronic device having a customer mobile application, a marine electronic device having a marine driver mobile application, a communication network connecting said customer electronic device and said marine electronic device, and a server system, wherein said server system provides access to a plurality of customer services for said customer mobile application and said marine driver mobile application;
providing a plurality of customer interfaces through said customer mobile application for customers to request said plurality of customer services;
providing a plurality of marine driver interfaces through said marine driver mobile application for marine drivers to accept said plurality of customer services;
wherein said plurality of customer services are selected from the group consisting of a tracking a boat location, tracking a customer location, a boat service type, making a payment, receiving a payment;
wherein said server system having a customer profile database including customer information selected from the group consisting of contact information, transaction history, ratings, and reviews;
wherein said server system having a marine driver profile database including marine driver information selected from the group consisting of certifications, license details, training details, reviews, and ratings; and
further wherein said boat service type is selected from the group consisting of boat ride sharing, delivery of fuel, delivery of spare parts, towing services, captaining services, and charter services.

10. The method of boat ride sharing and marine assistance of claim 9, wherein said server system having a matching module to identify the marine drivers based on parameters of said plurality of customer services.

11. The method of boat ride sharing and marine assistance of claim 10, wherein said server system having said matching module to identify the marine drivers based on proximity between the customer and the marine driver.

12. The method of boat ride sharing and marine assistance of claim 11, wherein said matching module autonomously broadcasts said plurality of customer services requested from the customer to all the identified marine drivers.

13. The method of boat ride sharing and marine assistance of claim 12, wherein the marine drivers can accept or decline the request of said boat service type.

14. The method of boat ride sharing and marine assistance of claim 13, wherein said customer electronic device and said marine electronic device are GPS-enabled devices for detecting a real-time location of said customer electronic device and said marine electronic device.

15. The method of boat ride sharing and marine assistance of claim 14, wherein said server system tracks the real-time location of said customer electronic device and said marine electronic device of all marine drivers and customers.

16. The method of boat ride sharing and marine assistance of claim 15, wherein said matching module uses the real-time location of the customers and the marine drivers to find the nearest available marine driver relative to the customer.

17. A method of boat ride sharing and marine assistance, the method comprising the steps of:
providing a customer electronic device having a customer mobile application, a marine electronic device having a marine driver mobile application, a communication network connecting said customer electronic device and said marine electronic device, and a server system, wherein said server system provides access to a plurality of customer services for said customer mobile application and said marine driver mobile application;
providing a plurality of customer interfaces through said customer mobile application for customers to request said plurality of customer services;
providing a plurality of marine driver interfaces through said marine driver mobile application for marine drivers to accept said plurality of customer services;
wherein said plurality of customer services are selected from the group consisting of a tracking a boat location, tracking a customer location, a boat service type, making a payment, receiving a payment;
wherein said server system having a customer profile database including customer information selected from the group consisting of contact information, transaction history, ratings, and reviews;
wherein said server system having a marine driver profile database including marine driver information selected from the group consisting of certifications, license details, training details, reviews, and ratings;
wherein said boat service type is selected from the group consisting of boat ride sharing, delivery of fuel, delivery of spare parts, towing services, captaining services, and charter services;
accepting at least one of said plurality of customer services by one of the marine drivers; and
assigning said at least one of said plurality of customer services to said one of the marine drivers.

18. The method of boat ride sharing and marine assistance of claim 17, wherein said captaining services includes accepting by one of the marine drivers temporary captaining of a boat of the customer.

19. The method of boat ride sharing and marine assistance of claim 18, wherein said server system having a matching module to identify the marine drivers based on parameters of said plurality of customer services, and further wherein said server system having said matching module to identify the marine drivers based on proximity between the customer and the marine driver.

20. The method of boat ride sharing and marine assistance of claim 19, wherein said server system tracks the real-time location of said customer electronic device and said marine electronic device of all marine drivers and customers, and further wherein said matching module uses the real-time location of the customers and the marine drivers to find the nearest available marine driver relative to the customer.
